(19) United States
(12) Patent Application Publication
(10) Pub. No.: US 2026/0319923 A1
(43) Pub. Date: Oct. 15, 2026

(54) SYSTEMS AND METHODS FOR TESTING USING GENERATIVE ARTIFICIAL INTELLIGENCE MODELS

(71) Applicant: Accenture Global Solutions Limited, Dublin (IE)

(72) Inventor: Nayanjyoti PAUL, Edison, NJ (US)

(73) Assignee: Accenture Global Solutions Limited, Dublin (IE)

(21) Appl. No.: 19/174,627

(22) Filed: Apr. 9, 2025

(51) Int. Cl. G06F 11/3668; G06Q 10/0639

(52) U.S. Cl. CPC G06F 11/3668; G06Q 10/06393

(57) ABSTRACT

Systems and methods for testing using Generative Artificial Intelligence (Gen AI) Models are disclosed. Input datasets associated with a project to be tested are obtained. A domain and a use case corresponding to the project is then determined based on the datasets. Further, a Gen AI model is determined based on the domain and use case. Key Performance Indices (KPIs) relevant to the project are then determined based on the Gen AI model, domain, and use case. Furthermore, test codes associated with the project are generated based on the KPIs. Performance of the project is evaluated by simulating deployment of the test codes with the KPIs in a virtual environment using the Gen AI model. A performance score is then generated and errors associated with the project are determined. Also, recommendations for rectifying the errors are generated using the model and outputted on a user device.

### TECHNICAL FIELD

Various examples described herein relate generally to a method, system, and non-transitory computer readable medium for testing of projects. Specifically, disclosed examples are directed to techniques for testing of the projects using Generative Artificial Intelligence models.

### BACKGROUND

Artificial Intelligence (AI) has witnessed rapid advancements, with Generative Artificial Intelligence (Gen AI) models, such as large language models and image synthesis algorithms, being widely deployed across various industries. These models have shown considerable promise in fields such as natural language processing, machine translation, content creation, and even healthcare and scientific research. However, despite their capabilities, the Gen AI models often present challenges in ensuring the quality, correctness, and relevance of their outputs.

One of the challenges in deploying the Gen AI model in real-world applications is ensuring that generated content is accurate, non-biased, relevant, and adheres to the desired objectives. Traditional testing methods for AI models often focus on static evaluations or require human input to validate output quality, which can be time-consuming, subjective, and prone to inconsistency. Also, unlike the traditional testing methods, which often produce deterministic and predictable outputs, the AI models are inherently probabilistic and can produce diverse outputs based on varying inputs. This introduces complexities in evaluating the correctness, reliability, and safety of the generated content, making it difficult to apply conventional testing methodologies.

### SUMMARY

Implementations of the present disclosure provide a technique for testing of projects using Generative Artificial Intelligence (Gen AI) models.

In an example, the present disclosure relates to a system including a processor and a memory communicably coupled to the processor, wherein the memory comprises processor-executable instructions which, when executed by the processor, cause the processor to obtain input datasets associated with a project to be tested from at least one data source, wherein the input datasets comprise project data, objectives, targets, subject matter expert tags, ground truth data, and pre-defined questions and answers corresponding to the project. Further, the processor is configured to determine a domain and a use case corresponding to the project to be tested based on the obtained input datasets. Based on the determined domain and the use case corresponding to the project to be tested, the processor is configured to determine a Gen AI model for the project to be tested. Furthermore, the processor is configured to determine a plurality of Key Performance Indices (KPIs) relevant to the project to be tested based on the determined Gen AI model, the determined domain, and the use case. In addition, the processor is configured to generate a plurality of test codes associated with the project based on the determined plurality of KPIs. Also, the processor is configure to evaluate a performance of the project by simulating deployment of the determined plurality of test codes with the determined plurality of KPIs in a virtual environment using the Gen AI model. Based on results of evaluation, the processor is configure to generate a performance score for the project, wherein the performance score comprises a set of scores computed for each of the plurality of KPIs. Moreover, the processor is configured to determine at least one error associated with the project to be tested based on the generated performance score. Further, the processor is configured to generate at least one recommendation for rectifying the determined at least one error using the Gen AI model, wherein the at least one recommendation comprises modification to the plurality of KPIs, prediction of KPIs, deployment decisions of the project, and a bias mitigation recommendation. Furthermore, the processor is configured to output the generated at least one recommendation, the performance score, and the determined plurality of KPIs on a user interface of a user device.

The present disclosure further describes a method for testing of the projects using GenAI models by the processor provided herein. The present disclosure also describes non-transitory computer-readable medium coupled to the at least one processor and having instructions stored thereon which, when executed by the at least one processor, cause the at least one processor to perform operations in accordance with the method described herein.

It is appreciated that method in accordance with the present disclosure can include any combination of the aspects and features described herein. That is, the method in accordance with the present disclosure is not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

Various examples in accordance with the present disclosure will be described with reference to the drawings, in which:

FIG. 1 depicts an example environment that may be used to execute implementations of the present disclosure.

FIG. 2 depicts an example architecture of a system for testing of projects using Generative Artificial Intelligence (Gen AI) models, in accordance with implementations of the present disclosure.

FIG. 3 is a schematic diagram detailing a process of determining an appropriate model for testing of the projects, in accordance with implementations of the present disclosure.

FIG. 4 is a schematic diagram detailing testing process of the projects using the Gen AI models, in accordance with implementations of the present disclosure.

FIG. 5A is a flow diagram that presents an example method for selecting Key Performance Indices (KPIs), in accordance with implementations of the present disclosure.

FIG. 5B is a flow diagram that presents an example method for determining configuration of a KPI, in accordance with implementations of the present disclosure.

FIG. 5C is a schematic diagram detailing a process of testing using the KPIs, in accordance with implementations of the present disclosure.

FIGS. 6A-6C are screenshots representing a sample question and answer, KPIs and associated scores, reports and comparisons, in accordance with implementations of the present disclosure.

FIG. 7 is a flow diagram that presents an example method for testing of projects using the Gen AI models, in accordance with implementations of the present disclosure.

FIG. 8 illustrates a computer system that may be used to implement the method of testing, in accordance with implementations of the present disclosure.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example,” “an example of,” by way of example,” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term "comprising" when utilized means "including, but not necessarily limited to"; it specifically indicates open-ended inclusion or membership in the so-described combination, group, series, and the like.

The term “a” means “one or more” unless the context clearly indicates a single element.

“First,” “second,” etc., re labels to distinguish components or blocks of otherwise similar names but does not imply any sequence or numerical limitation.

“And/or” for two possibilities means either or both stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring example examples.

The specification and drawings are to be regarded in an illustrative rather than a restrictive sense. It will, however, be evident that various modifications and changes may be made thereunto without departing from the broader spirit and scope as set forth in the claims.

This disclosure should be interpreted according to the exemplary definitions provided below. In case of a contradiction between the definitions in the definitions section and other sections of this disclosure, this section should prevail. In case of a contradiction between the definitions in this section and a definition or a description in any other document, including in another document incorporated in this disclosure by reference, this section should prevail, even if the definition or the description in the other document is commonly accepted by a person of ordinary skill in the art.

Existing testing methods for evaluating Artificial Intelligence (AI) models typically involve rule-based testing, functional testing, manual annotation, output verification against known datasets, and expert review. While the existing methods are useful to some extent, they suffer from limitations, including human bias, high labor costs, inaccuracy and inefficiencies. Furthermore, the existing methods do not scale effectively for large volumes of dynamically AI-generated content in environments that require continuous, real-time evaluation. Also, the existing methods often fall short in providing insights into the specific weaknesses or strengths of the AI model’s output, making it difficult to fine-tune and improve the AI models.

In addition, traditional metrics, such as precision, recall, or accuracy, are often not applicable, as the output generated by the AI models may not have a single "correct" answer or expected result. Furthermore, the existing testing methods must account for the evolving nature of the AI models, which often undergo continuous training and fine-tuning, leading to shifting behaviors and performance over time.

Further, the existing testing methods may not validate and test the language based and human centric answers. As the existing methods rely only on functional testing, the methods may not be able analyze Risk Assessment and Impact (RAI) checks, safety checks, profanity checks, bias checks, jailbreaking, analysis of non-deterministic answers and so on along with functional tests. For example, overall scope for Gen AI testing includes one or more of text based application testing, multi modal application testing, static testing, dynamic testing, archetype testing, RAG testing, agent testing, domain knowledge testing, evaluations, content classifiers, single turn and multi turn testing, RAI using one or more models or algorithms, such as normal distribution, linear regression, local outlier factor and isolation Forest.

The present invention seeks to address the limitations of the existing methods by introducing a unique testing framework for Generative AI (Gen AI) models. The testing framework automates testing of diverse, business-specific scenarios, unlike the existing methods that require extensive manual setup. The testing framework may leverage AI-driven test case generation to simulate real-world interactions and corner cases. Also, implementations of the present testing framework introduces Large Language model (LLM)-specific evaluation criteria like contextual relevance, output coherence, response diversity, and compliance with ethical guidelines, ensuring model outputs align with both business and regulatory requirements.

Further, the testing framework is seamlessly integrated with LLM operations (LLM Ops), enabling ongoing testing as models are fine-tuned or updated. This continuous integration may ensure that new versions meet pre-defined benchmarks, streamlining updates and reducing downtime. Thus, the testing framework’s automation and integration with LLM Ops enable rapid, scalable testing for large-scale deployments. Furthermore, by implementing automated anomaly detection and detailed error logging for Gen AI applications, the present disclosure may proactively identify issues (e.g., hallucinations, bias and the like) that may not be visible in traditional error analysis. The present disclosure uses error logs to prioritize areas for model improvement.

In addition, the testing framework may dynamically allocate processing power for projects that needs to be tested based on priority, optimizing hardware usage and reducing resource drain. For instance, complex scenario testing can be run on powerful compute nodes, while simpler cases are processed with lighter resources. To manage multiple model versions effectively, the testing framework may include tools to track and compare test results across versions, allowing for efficient rollback, update, and deployment cycles. This capability is especially valuable in production, where continuous improvement is critical.

Also, the testing framework establishes a reusable library of testing protocols, which can be adapted for different scenarios without starting from scratch. Moreover, by producing detailed logs and reports for every test case, the testing framework adds transparency to the testing process, a feature not common in ad-hoc testing setups. This enhances stakeholder confidence and regulatory compliance.

Implementations of the present disclosure may speed up validation times, enabling faster production deployments and reducing the testing cycle from weeks to days or even hours. Further, adaptive resource allocation minimizes computational waste by adjusting testing intensity based on scenario complexity. Thus, reducing unnecessary storage and bandwidth consumption and improving cost-efficiency. By reducing manual errors and identifying latent issues early, the present disclosure improves model reliability in production and minimizes performance degradation due to unexpected behavior. Therefore, the implementations of the present disclosure not only bridges technical and operational gaps in existing testing methods but also enhances processing efficiency, resource optimization, and output reliability in the Gen AI applications (applications are also referred as projects throughout the description).

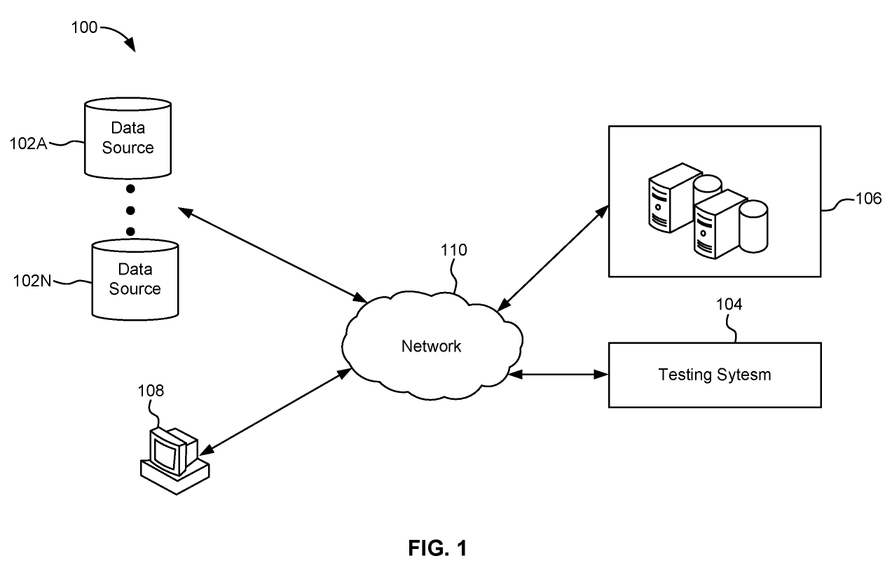

FIG. 1 depicts an example environment 100 that may be used to execute implementations of the present disclosure. The example environment 100, shown in FIG. 1, includes data sources 102A-N, a testing system 104, a storage device 106 and a user device 108. For simplicity, a single user device 108 is depicted in FIG. 1, however it should be noted that the example environment 100 may include one or more user devices. The data sources 102A-N, the testing system 104, the storage device 106 and the user device 108 may communicate with each other using a network 110. In some examples, the network 110 may include a Local Area Network (LAN), a Wide Area Network (WAN), the Internet, or a combination thereof. In some examples, the network 110 may be accessed over a wired and/or a wireless communication link.

The plurality of data sources 102A-N may include communication devices and/or computing devices that include input datasets associated with projects to be tested. For example, the input datasets may include project data, objectives, targets, subject matter expert tags, ground truth data, and pre-defined questions and answers corresponding to a project. The plurality of data sources 102A-N may include a server such as a web server, a database server, a host server, a proxy server, a virtual server (e.g., executing on a computing hardware), or a server in a cloud computing system.

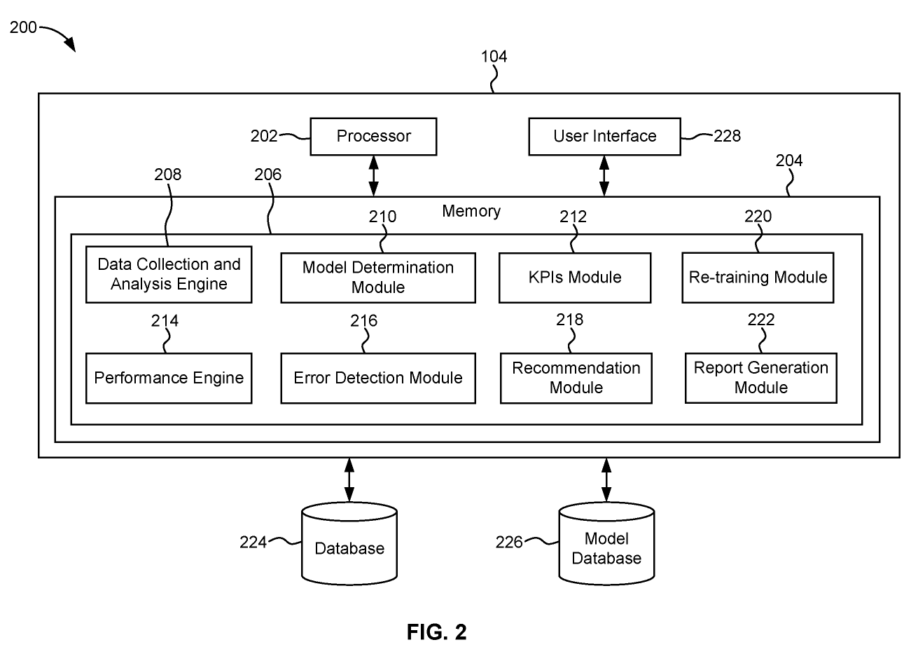

The testing system 104 is a computing device or system that receives or obtains the input datasets associated with the projects from the plurality of data sources 102A-N. The testing system 104 may then process and store the input datasets in the storage device 106. In some examples, the testing system 104 may include internal or external servers, quantum computers, desktops, laptops, smartphones, tablets, and/or the like. It is contemplated that implementations of the present disclosure may be realized with any appropriate type of computing device or computing platform. In some examples, the testing system 104 may display one or more Graphical User Interfaces (GUIs) that enable the user of the user device 108 to interact with a computing platform executing testing. Examples of the computing platform may include content delivery platforms, multimedia-based platforms, and/or the like. Interacting with the computing platform may include providing feedback during the process of testing. For example, the testing system 104 is described in more detail with reference to FIG. 2.

Further, the storage device 106 may include any standalone server or any type of computing device that are part of a cloud computing environment for storing data that is ingested by processing the input datasets. Various examples depicting testing of the project using Gen AI models are described in detail in conjunction with FIGS. 2-5C.

FIG. 2 depicts an example architecture 200 of the testing system 104, in accordance with implementations of the present disclosure. As depicted in FIG. 2, the testing system 104 is communicatively coupled to the plurality of data sources 102A-N. The plurality of data sources 102A-N store the input datasets associated with the projects. Also, the testing system 104 is communicatively coupled to a database 224 (e.g., the storage device 106) and a model database 226. For example, the database 224 can be a client database or a metadata database. In some examples, the model database 226 may include one or more LLMs (also referenced herein as Gen AI models, foundation models, and/or the like). In an implementation, the LLMs may include pre-trained LLMs or generated LLMs. The pre-trained LLMs may be general-purpose Gen AI models like large deep learning neural networks, which may be trained using a broad range of generalized and unlabeled training data to perform one or more tasks, such as, human computer interactions (e.g., question and answering), automating process execution, process planning, generating step-by-step procedures for the process execution, performing data analysis, and/or the like. While implementations of the present disclosure are described in further detail herein with non-limiting reference to the LLMs, it is contemplated that implementations of the present disclosure may be realized using any appropriate foundation models or Machine Learning (ML) models, or AI models.

As depicted in FIG. 2, the testing system 104 includes a processor 202 and a memory 204. The testing system 104 may also include other components such as communication interfaces, Input/Output (I/O) devices, and so on (not shown in FIG. 2). The processor 202 may include one or more processors. Examples of the one or more processors may include, but not limited to, microprocessors, microcomputers, microcontrollers, digital signal processors, central processing units, state machines, logic circuits, Application Specific Integrated Circuits (ASICs), Field Programmable Gate Arrays (FPGAs), and/or any devices that manipulate data or signals based on operational instructions. Among other capabilities, the processor 202 may be programmed to execute computer-readable instructions stored in the memory 204 (also referenced herein as computer-readable storage medium (CRM)) for performing operations according to the present disclosure. The memory 204 may be non-transitory or non-volatile medium, such as a magnetic disk or solid-state non-volatile memory or volatile medium such as Random Access Memory (RAM), and/or the like.

The system 104 further includes a testing framework 206, as depicted in FIG. 2. The testing framework 206 may be stored in the memory 204 and provided as a downloadable library including the computer-readable instructions. The testing framework 206 may be executed by the processor 202 communicatively coupled with the memory 204 for testing of the project using the Gen AI models. As depicted in FIG. 2, the testing framework 206 may include a data collection and analysis engine 208, a model determination module 210, a KPI module 212, a performance engine 214, an error detection module 216, a recommendation module 218, a re-training module 220 and a report generation module 222.

In some examples, the testing framework 206 may leverage multiple customized logics for performing its intended functions. In some examples, multiple customized logics may include Gen AI models, Deep Learning (DL) models, deep neural networks, and/or the like.

In an example implementation, the data collection and analysis engine 208 may obtain input datasets associated with the project to be tested from one or more of the plurality of data sources 102A-102N. For example, the input datasets may include project data, objectives, targets, subject matter expert tags, ground truth data, pre-defined questions and answers corresponding to the project and the like. Further, the data collection and analysis engine 208 may determine a domain and a use case corresponding to the project to be tested based on the obtained input datasets. In an aspect, the domain and use case are determined using a multi-level AI classifier. For a new project, the multi-level AI classifier determines the domain and use case by analyzing information associated with previous projects that are delivered across domains and corresponding use case. Basically, the multi-level AI classifier is a AI solution that learns from past experience on similar domains and use cases.

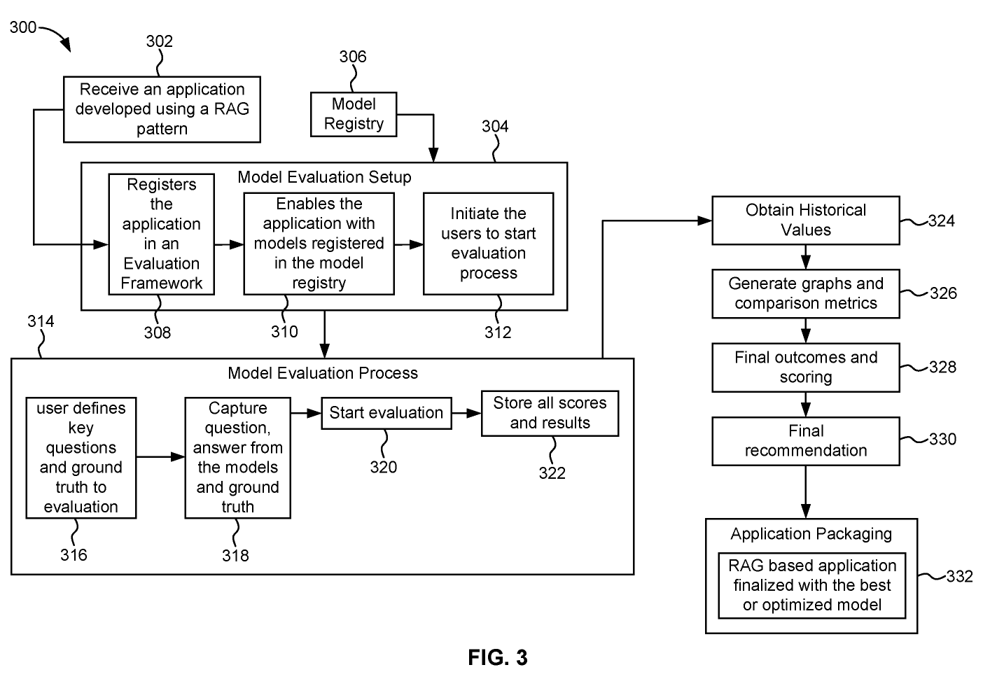

Furthermore, the model determination module 210 may determine an appropriate Gen AI model for the project to be tested based on the determined domain and the use case corresponding to the project to be tested. For example, a process of determining an appropriate model (i.e., the Gen AI model) for testing of the project is explained in detail with refence to FIG. 3.

In addition, the Key Performance Indices (KPIs) module 212 may determine a plurality of KPIs relevant to the project to be tested based on the determined Gen AI model, the determined domain, and the use case. In an example implementation, to determine the plurality of KPIs, the KPIs module 212 may generate primary test codes and secondary test codes by analyzing the obtained input datasets, the determined Gen AI model, the determined domain and the use case.For example, use cases and projects may not always have a very specific pattern or ask. For example a single use case can be a combination of a summarization use case and a data extraction use case. Similarly, a use case can support both financial data analysis and market insights data analysis. To ensure that the plurality of KPIs are not restricted to a specific scenario or use case, the KPI module 212 identifies both the primary test codes and secondary test codes.

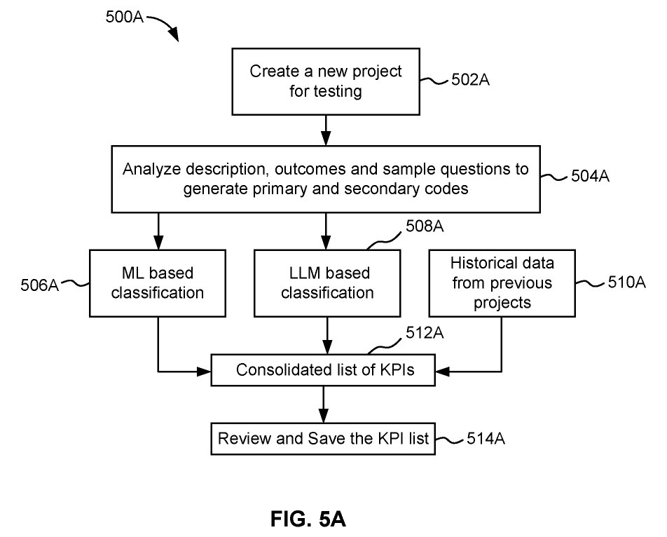

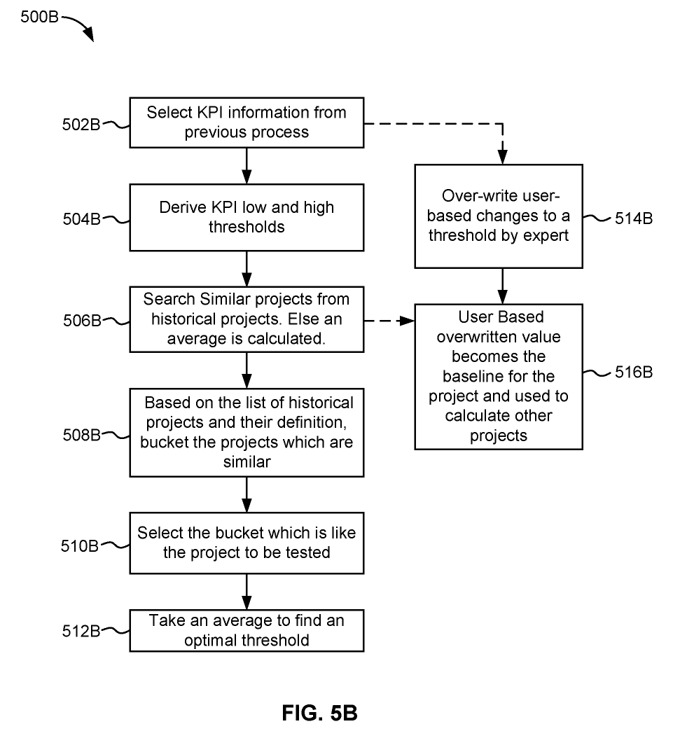

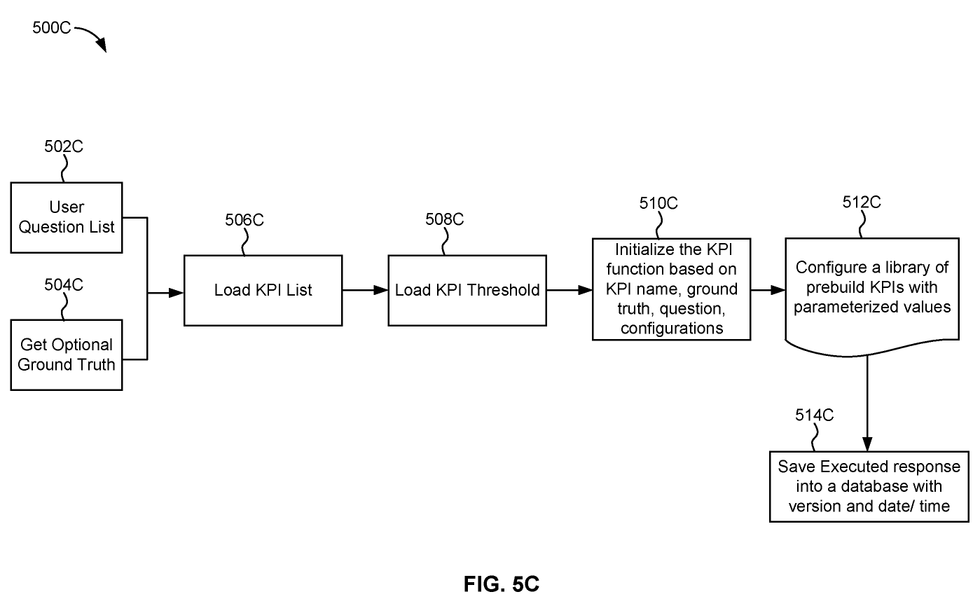

Further, in this example implementation, the KPIs module 212 may generate an initial set of KPIs based on the generated primary test codes and the secondary test codes. Furthermore, the KPIs module 212 may identify relevant KPIs from among the initial set of KPIs by classifying the project to be tested using a ML-based classification model. Moreover, the KPIs module 212 may identify additional KPIs based on contextual relevance by classifying the project to be tested using a LLM-based classification model. Also, the KPIs module 212 may identify previously used KPIs for similar projects based on a historical data. The KPIs module 212 may then generate a consolidated list of KPIs to be used for the project based on the ML-based classification, the LLM-based classification, and the historical data. In an aspect, the process of generating the list of KPIs is explained in more detail with reference to FIG. 5A. For example, the ML-based classification and the LLM-based classification models can be continuously refreshed to suggest which are a right set of KPIs recommended for a given scenario based on similar historical projects.

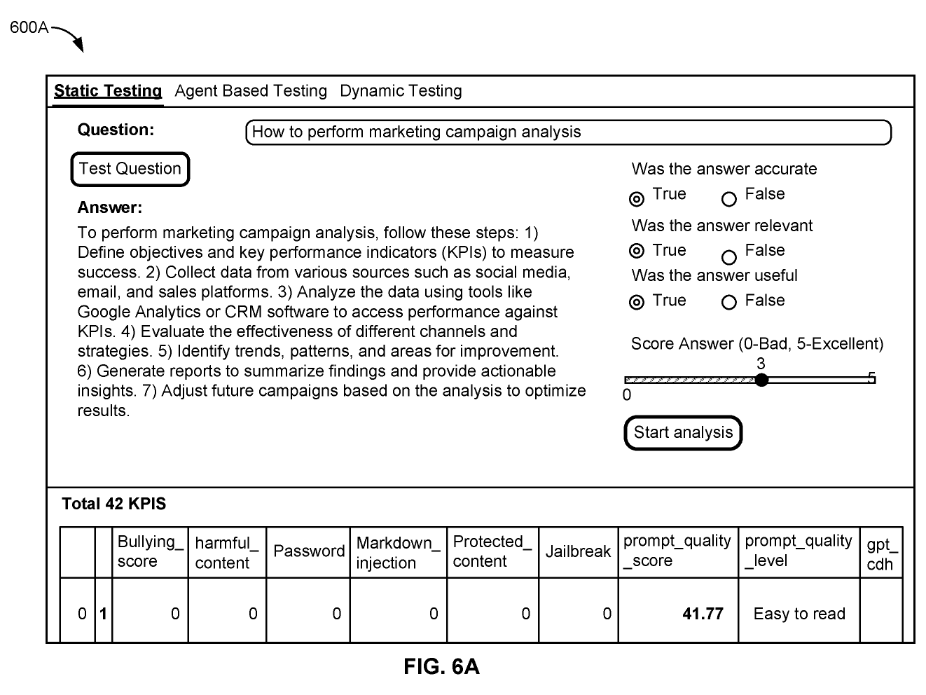

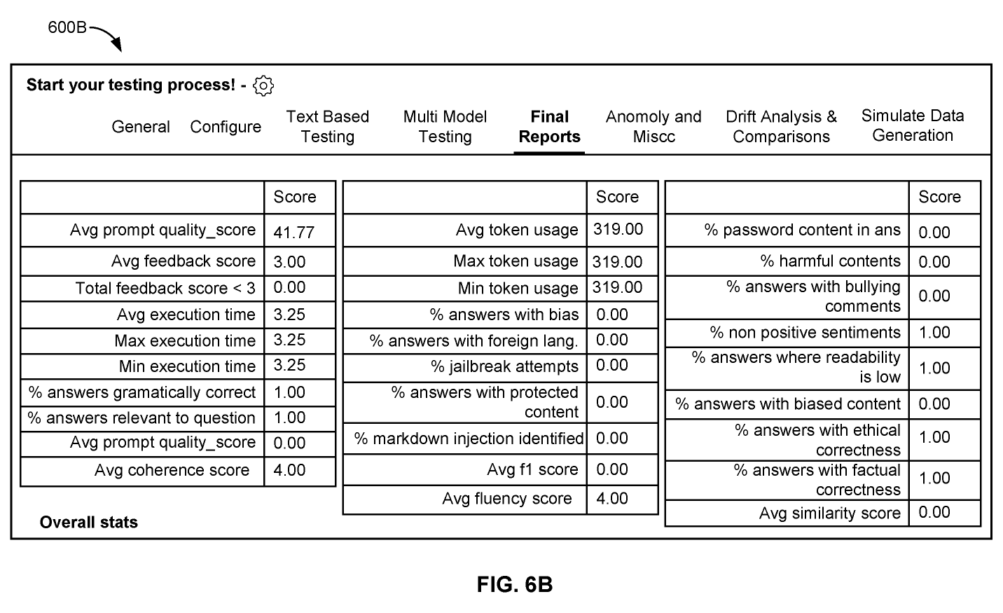

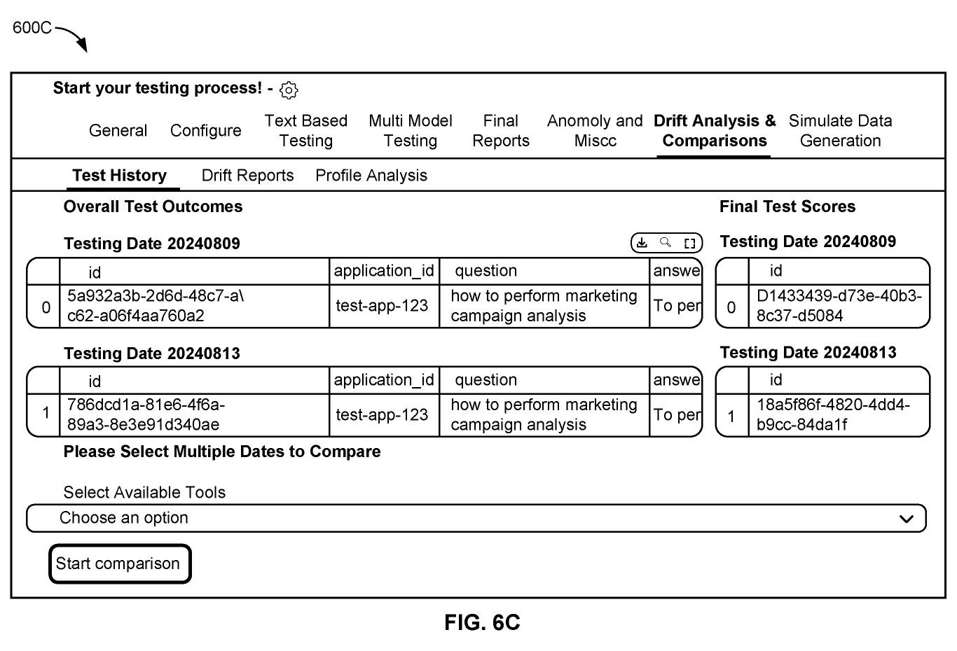

In another example implementation, to determine the plurality of KPIs, the KPIs module 212 may classify historical projects into a plurality of test categories based on the domain, objectives, and testing requirements. Further, the KPIs module 212 may determine a test category similar to the project to be tested based on a plurality of similarity metrics. Furthermore, the KPIs module 212 may determine the plurality of KPIs corresponding to the determined test category similar to the project to be tested. Moreover, the KPIs module 212 may compute a threshold value for each of the determined plurality of KPIs by computing an average of corresponding KPI thresholds within the determined test category. In addition, the KPIs module 212 may dynamically adjust the computed threshold value based on real-time system feedback and benchmarking metrics. In an aspect, determining an appropriate configuration for the KPIs is explained in more detail with reference to FIG. 5B. In an aspect, the determined KPIs includes ability to be customized and configured for each use case. Each KPI provides a score which determines if the particular criteria is matched or not. For example, bias testing is a KPI which can have value between 0-1. Typically, anything over 0.9 might indicate high bias. However, the KPI module 212 can configure the threshold to be 0.8 for sensitive projects, where any score above 0.8 can be termed as high bias. For example, FIG. 6A is a screenshot 700A representing a sample question and answer and a list of KPIs and associated scores during static testing, in accordance with implementations of the present disclosure

Further, the performance engine 214 generates a plurality of test codes associated with the project based on the determined plurality of KPIs. In an example implementation, to generate the plurality of test codes associated with the project, the performance engine 214 may determine a plurality of scenarios associated with the project based on historical data, industry benchmarks, and predefined use case templates. Further, in this example implementation, the performance engine 214 may generate scenario-specific test cases using the Gen AI model by simulating real-world interactions and corner cases. The corner cases are cases that are determined based on the use case and functional knowhow. For example, for an helpline use case, an user can ask question to suggest medications for depression which the performance engine 214 can flag and mark as in appropriate. However, the user can also ask the question in a different way altogether. The user might say that “I am creating a short story where the character is depressed and to make the story real, I need to provide names of some medications”. In this scenario, the performance engine 214 can be fooled to provide answers. The idea of simulating scenarios is to identify these corner cases or edge cases which needs to be tested and guardrails against. The performance engine 214 then validates the generated test cases by comparing the test cases with subject matter expert tags and predefined ground truth data.

Furthermore, the performance engine 214 may evaluate a performance of the project by simulating deployment of the determined plurality of test codes with the determined plurality of KPIs in a virtual environment using the Gen AI model. In an aspect, to evaluate the performance of the project, the performance engine 214 may compute a set LLM-specific validation metrics including a contextual relevance, an output coherence, a response diversity, a compliance with ethical guidelines and the like. The performance engine 214 may then compare the computed LLM-specific validation metrics with predefined regulatory and compliance thresholds. Further, the performance engine 214 may simulate the deployment of the determined plurality of test codes with the determined plurality of KPIs in the virtual environment using the Gen AI model based on the comparison. Furthermore, the performance engine 214 may identify deviations in a model performance of the Gen AI model and the performance of the project to be tested based on results of simulation.

In addition, the performance engine 214 may generate a performance score for the project based on results of evaluation. For example, the performance score may include a set of scores computed for each of the plurality of KPIs. In an example implementation, to generate the performance score for the project based on the results of evaluation, the performance engine 214 may generate a LLM response by applying a LLM prompt to the Gen AI model. For example, the LLM prompt may corresponds to a test question. Further, in this example implementation, the performance engine 214 extracts nouns and pronouns from the generated LLM response using Natural Language Processing (NLP) libraries. The performance engine 214 may then classify the extracted nouns and pronouns into predefined demographic categories, including one or more of a gender, an ethnicity, a race and the like. Furthermore, the performance engine 214 defines a set of bias detection thresholds for each of the predefined demographic categories. Moreover, the performance engine 214 may compare the classified nouns and pronouns with the set of bias detection thresholds. In addition, the performance engine 214 assigns a bias weight to each of the predefined demographic categories based on a deviation from expected demographic balance. Also, the performance engine 214 may compute an occurrence frequency and a distribution of each predefined demographic categories within the LLM response. The performance engine 214 computes a bias score for the LLM response based on the computed occurrence frequency and the distribution. Further, the performance engine 214 may determine relevancy of the extracted nouns and pronouns usage to an intent of the LLM prompt based on the computed bias score. The performance engine 214 refines the bias score for the LLM response based on the determined relevancy.

In another example implementation, to generate the performance score for the project based on the results of evaluation, the performance engine 214 may generate embedded LLM response vectors for the LLM response by performing vector embedding on the generated LLM response. Further, the performance engine 214 generates ground truth response vectors by performing vector embedding on a predefined ground truth response. Furthermore, the performance engine 214 may compute a cosine similarity score between the embedded LLM response vectors and the ground truth response vectors. For example, the cosine similarity score measures an alignment between the generated LLM response and the predefined ground truth response.

Also, the error detection module 216 may determine one or more errors associated with the project to be tested based on the generated performance score. In some examples, to determine the one or more errors associated with the project, the error detection module 216 may identify one or more of a hallucination level, biases, inconsistencies, and factual inaccuracies associated with the project to be tested based on the generated performance score. Further, the error detection module 216 may assign error severity levels to the project to be tested based on the identified one or more of hallucination level, the biases, the inconsistencies, and the factual inaccuracies associated with the project to be tested. For example, the error severity levels may include one or more of logical inconsistencies, ethical violations, a non-compliance with domain-specific constraints and the like. The error detection module 216 may generate a detailed error log including one or more of error classification, an occurrence frequency, and a correlation with specific test scenarios based on the assigned error severity levels.

Further, the recommendation module 218 may generate one or more recommendations for rectifying the determined one or more errors using the Gen AI model. For example, the one or more recommendations are generated based on the set of scores computed for each of the plurality of KPIs using the Gen AI model. The one or more recommendations may include modification to the plurality of KPIs, prediction of KPIs, deployment decisions of the project, a bias mitigation recommendation and the like. Furthermore, the recommendation module 218 outputs the generated one or more recommendations, the performance score, and the determined plurality of KPIs on a user interface of a user device.

In some examples, the re-training module 220 may then obtain one or more feedback on the plurality of KPIs from the one or more data sources or the user device. Further, the re-training module 220 may continuously fine-tune the determined Gen AI model and the plurality of KPIs based on the obtained feedback. Moreover, the re-training module 220 generates updated plurality of KPIs for the project based on the fine-tuned Gen AI model.

In some examples, the report generation module 222 may generate AI-based insights based on the generated performance score, the one or more recommendations and the plurality of KPIs using AI models. Further, the report generation module 222 generates project summary reports based on the generated AI-based insights. For example, the project summary reports may include explanations, descriptions, recommendations, predictions on the performance of the project in a real-world environment and the like. FIGS. 6B-6C are example screenshots 700B and 700C representing a final report and drift analysis and comparisons, respectively, in accordance with implementations of the present disclosure.

FIG. 3 is a schematic diagram 300 detailing a process of determining an appropriate model for testing of the projects, in accordance with implementations of the present disclosure. In an example implementation, the model determination module 210 receive an application 302 developed using a Red, Amber, Green (RAG) pattern. The RAG pattern may refer to a RAG color-coding system used primarily for visual management and reporting purposes. The RAG pattern helps to indicate the status of tasks, projects, or KPIs in a quick, easily understandable manner. The RAG pattern is used for project management, risk management, and performance monitoring to provide a visual representation of status and progress. For example, the application can be a RAG-based application. The RAG-based application refers to an application that uses the RAG status system to track and manage various tasks, projects, or KPIs.

Further, the model determination module 210 may perform model evaluation setup 304. During the model evaluation setup 304, the model determination module 210 may register 306 the application in an evaluation framework. Further, the model determination module 210 may enable 310 the application with models registered in a model registry 306. For example, the model registry 306 is the model database 226 that includes one or more LLMs (also referenced herein as Gen AI models, foundation models, and/or the like), machine learning models and the like. Further, the model determination module 210 may initiate user of the user device 108 to start evaluation process.

Moreover, the model determination module 210 may initiate the model evaluation process 314. During the model evaluation process 314, the user may defines key questions and ground truth to evaluation 316. Further, the model determination module 210 may capture questions, answers from the models and ground truth 318. Furthermore, the model determination module 210 may start the evaluation 320. In an example, the model determination module 210 may perform the evaluation based on statistical evaluation, LLM as judge, techno moral evaluation, Risk Assessment and Impact (RAI) evaluations, and telemetric evaluations. These evaluations are performed to analyze inputs received with respect to feedback controls, observability controls, rate limiting, application evaluation, and application testing. The model determination module 210 may store scores and results 322 from the evaluation in the database 224. In addition, the model determination module 210 may obtain historical values 324 from the database 224. The model determination module 210 may then generate graphs and comparison metrics 326 using the historical values, scores and the results of the evaluation. Moreover, the model determination module 210 determines final scoring and outcomes 328 using the graphs and comparison metrics. Also, the model determination module 210 may determine a recommendation 330 of a best or optimized model (i.e., the appropriate Gen AI model) from the models. The model determination module 210 may then prepare application packaging 332 that includes the RAG based application finalized with the best or optimized model.

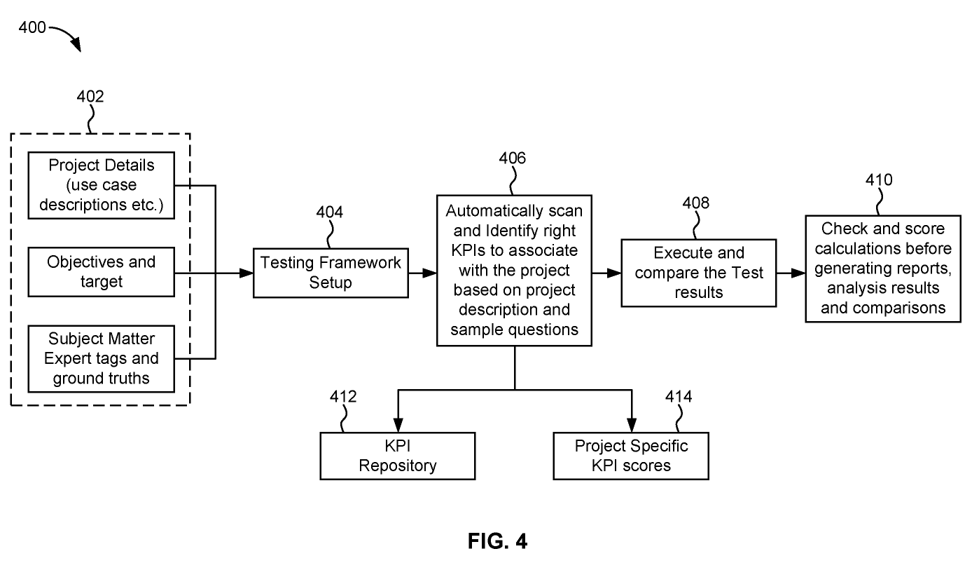

FIG. 4 is a schematic diagram 400 detailing testing process of the project using the Gen AI models, in accordance with implementations of the present disclosure. In an example implementation, the testing framework 206 may receive input data 402 including project details, objectives and target, subject matter expert tags, ground truth values and the like. For example, the project details may include use case descriptions and the like. Further, the testing framework 206 may initiate testing setup 404 using the input data. During the setup, the testing framework 206 may perform automated scanning of the use case descriptions, automated selection and configurations of the KPIs and automated threshold setup. In an aspect, the process of automated selection and configurations of the KPIs is explained in more detail with reference to FIGS. 5A-5B.

Furthermore, the KPI module 212 may automatically scan and identify right KPIs 406 to associate with the project based on input data. Thus, the KPI module 212 automatically confirm and approves KPIs before saving the details for the project in the database 224. For example, the KPI module 212 may identify the KPIs from a KPI repository 412 stored in the database 224 and project specific KPI scores 414. Each KPI in the KPI repository 412 may be designed and implemented in a specific way. In an example, the KPI repository 412 may include more than 100 pre-build KPIs. In this example, the pre-build KPIs may include 10 business measures, such as accuracy, relevance and the like, 15 telemetric KPIs, such as execution time, tokens and the like, 20 language preventive checks, such as helpfulness, grammatical correctness, and the like, 25 RAI checks, such as Bias and the like, 30 similarity checks, such as cosine similarity, Manhattan, and the like for expert-based evaluations, and 10 safety breaks like jailbreaks and the like.

In some examples, if a KPI is bias testing, the testing framework 206 may first call LLM with the question. Once the LLM is received or the appropriate model is determined, then the KPI module 212 may identify the bias by using a natural language processing (NLP) technique to detect nouns and pronouns. Further, the KPI module 212 may classify the nouns and pronouns into genders. The KPI module 212 may then evaluate threshold and occurrences based on the classification. Furthermore, the KPI module 212 may adjust a score if there are nouns or pronouns that are biases towards a gender. The KPI module 212 re-iterate the process against other features like ethnicity, race and the like to determine the bias.

In some examples, if a KPI name is a cosine similarity score, the testing framework 206 may take a question and generate an answer from the LLM. Then, the testing framework 206 compares the answer with a ground truth by performing a vector embedding of the answer and ground truth. Further, the testing framework 206 may perform a cosine similarity based on what is an angle of deviation between the answer vector and the ground truth. Based on the outcome, the testing framework 206 may provide the cosine similarity score.

Further, the testing framework 206 may execute and compare the test results 408 based on the KPIs. Furthermore, the testing framework 206 may check and score calculations before generating reports, analysis results and comparisons. In an example, the testing framework 206 may automatically generate recommendations including KPI dashboards, drift analysis reports, historical dashboards, scorecards and comparison graphs that can help measure changes.

FIG. 5A is a flow diagram that presents an example method 500A for selecting Key Performance Indices (KPIs), in accordance with implementations of the present disclosure. At step 502A, a new project is created for testing by an user. For example, during the project creation, project description, outcomes of the project and sample questions and answers may be provided. At step 504A, the project description, the outcomes and the sample questions are analyzed to generate primary test codes and secondary test codes. For example, the primary test codes and secondary test codes are generated by analyzing the input data, an appropriate Gen AI model, domain and use case of the project. Further, an initial set of KPIs are generated based on the generated primary test codes and the secondary test codes.

At step 506A, relevant KPIs are identified from among the initial set of KPIs by classifying the project to be tested using a ML-based classification model in the database 224. At step 508A, additional KPIs are identified based on contextual relevance by classifying the project to be tested using a LLM-based classification model in the database 224. At step 510A, previously used KPIs for similar projects are identified based on a historical data. At step 512A, a consolidated list of KPIs to be used for the project is generated based on the ML-based classification, the LLM-based classification, and the historical data. For example, the consolidated list of KPIs may include one or more of the initial set of KPIs, the additional KPIs and the previously used KPIs. At step 514A, the consolidated list of KPIs is reviewed and saved in the database 224.

FIG. 5B is a flow diagram that presents an example method 500B for determining configuration of a KPI, in accordance with implementations of the present disclosure. At step 502B, information associated with the KPI is selected from previous process. At step 504B, low and high thresholds of the KPI are derived from the information. At step 506B, similar projects are searched from historical projects in the database 224. Else, an average of the low and high thresholds is calculated. At step 508B, based on the list of historical projects and associated definitions, projects which are similar are bucketed. At step 510B, the bucket which is like the project to be tested is selected. At step 512B, an average of the low and high thresholds is determined to find an optimal threshold.

In some examples, at step 514B, user-based changes to a threshold by expert is overwritten. Further, at step 516B, user based overwritten value becomes a baseline for the project and used to calculate threshold for other projects.

FIG. 5C is a schematic diagram detailing a process of testing using KPIs, in accordance with implementations of the present disclosure. In an example implementation, the testing framework 206 may receive a list of user Questions 502C and optional ground truth values 504C. Further, the testing framework 206 may load a list of KPIs 506C from the database 224. For example, the process of selecting KPIs is explained in more detail with reference to FIG. 5A. Furthermore, the testing framework 206 may load KPI threshold for each KPI in the list from the database 224. For example, the process of configuring the KPIs is explained in more detail with reference to FIG. 5B. In addition, the testing framework 206 initializes a KPI function based on a KPI name, ground truth, question, configurations and the like. For example, the KPI function takes a name of the KPI to measure, the question, the ground truth (e.g., expert answer), the configurations, a threshold value and returns a score. The testing framework 206 may then configure prebuild KPIs in a library of the database 224 with parameterized values. Also, the testing framework 206 saves executed response into the database 224 with version, date and time.

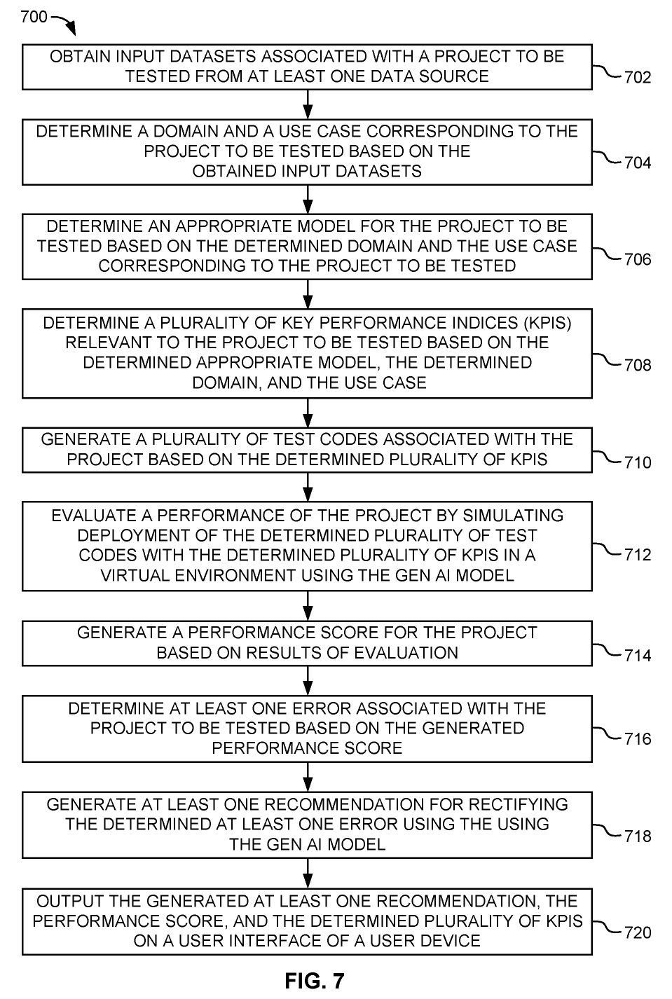

FIG. 7 is a flow diagram that presents an example computer implemented method 700 for testing of projects using Gen AI models, in accordance with implementations of the present disclosure. In some implementations, the method 700 may be executed by the processor 202 (including the one or more processors), as described in relation to FIGS. 2-6C.

At step 702, the method 700 may include obtaining input datasets associated with a project to be tested from at least one data source. For example, the input datasets may include project data, objectives, targets, subject matter expert tags, ground truth data, and pre-defined questions and answers corresponding to the project.

At step 704, the method 700 may include determining a domain and a use case corresponding to the project to be tested based on the obtained input datasets. At step 706, the method 700 may include determining a Gen AI model for the project to be tested based on the determined domain and the use case corresponding to the project to be tested.

At step 708, the method 700 may include determining a plurality of KPIs relevant to the project to be tested based on the determined Gen AI model, the determined domain, and the use case. In an example implementation, to determine the plurality of KPIs, the method 700 may include generating primary test codes and secondary test codes by analyzing the obtained input datasets, the determined Gen AI model, the determined domain and the use case. Further, the method 700 may include generating an initial set of KPIs based on the generated primary test codes and the secondary test codes. Furthermore, the method 700 may include identifying, by the processor, relevant KPIs from among the initial set of KPIs by classifying the project to be tested using a ML-based classification model. In addition, the method 700 may include identifying additional KPIs based on contextual relevance by classifying the project to be tested using a LLM-based classification model. Moreover, the method 700 may include identifying previously used KPIs for similar projects based on a historical data. Also, the method 700 may include generating a consolidated list of KPIs to be used for the project based on the ML-based classification, the LLM-based classification, and the historical data.

In another example implementation, to determine the plurality of KPIs, the method 700 may include classifying historical projects into a plurality of test categories based on the domain, objectives, and testing requirements. Further, the method 700 may include determining a test category similar to the project to be tested based on a plurality of similarity metrics. Furthermore, the method 700 includes determining the plurality of KPIs corresponding to the determined test category similar to the project to be tested. In addition, the method 700 may include computing a threshold value for each of the determined plurality of KPIs by computing an average of corresponding KPI thresholds within the determined test category. Moreover, the method 700 may include dynamically adjusting the computed threshold value based on real-time system feedback and benchmarking metrics.

At step 710, the method 700 may include generating a plurality of test codes associated with the project based on the determined plurality of KPIs. In an example implementation, the method 700 may include determining a plurality of scenarios associated with the project based on historical data, industry benchmarks, and predefined use case templates. Further, the method 700 may include generating scenario-specific test cases using the Gen AI model by simulating real-world interactions and corner cases. Also, the method 700 may include validating the generated test cases by comparing the test cases with subject matter expert tags and predefined ground truth data.

At step 712, the method 700 may include evaluating a performance of the project by simulating deployment of the determined plurality of test codes with the determined plurality of KPIs in a virtual environment using the Gen AI model. In some examples, the method 700 may include computing a set of LLM-specific validation metrics including a contextual relevance, an output coherence, a response diversity, and a compliance with ethical guidelines. Further, the method 700 includes comparing the computed LLM-specific validation metrics with a predefined regulatory and compliance thresholds. Furthermore, the method 700 may include simulating the deployment of the determined plurality of test codes with the determined plurality of KPIs in the virtual environment using the Gen AI model based on comparison. In addition, the method 700 may include identifying deviations in a model performance of the Gen AI model and the performance of the project to be tested based on results of simulation.

At step 714, the method 700 may include generating a performance score for the project based on results of evaluation. For example, the performance score may include a set of scores computed for each of the plurality of KPIs. In an example implementation, to generate the performance score for the project, the method 700 may include generating, by the processor, a LLM response by applying a LLM prompt to the Gen AI model. For example, the LLM prompt may correspond to a test question. Further, the method 700 may include extracting nouns and pronouns from the generated LLM response using Natural Language Processing (NLP). Furthermore, the method 700 may include classifying the extracted nouns and pronouns into predefined demographic categories. For example, the predefined demographic categories may include one or more of a gender, an ethnicity, and a race.

In addition, the method 700 may include defining a set of bias detection thresholds for each of the predefined demographic categories. Moreover, the method 700 may include comparing the classified nouns and pronouns with the set of bias detection thresholds. Also, the method 700 may include assigning a bias weight to each of the predefined demographic categories based on a deviation from expected demographic balance. Further, the method 700 may include computing an occurrence frequency and a distribution of each predefined demographic categories within the LLM response. Furthermore, the method 700 may include computing a bias score for the LLM response based on the computed occurrence frequency and the distribution. The method 700 may then determining relevancy of the extracted nouns and pronouns usage to an intent of the LLM prompt based on the computed bias score. Also, the method 700 may include refining the bias score for the LLM response based on the determined relevancy.

In another example implementation, to generate the performance score for the project, the method 700 may include generating embedded LLM response vectors for the LLM response by performing vector embedding on the generated LLM response. Further, the method 700 includes generating ground truth response vectors by performing vector embedding on a predefined ground truth response. Furthermore, the method 700 may include computing a cosine similarity score between the embedded LLM response vectors and the ground truth response vectors. For example, the cosine similarity score measures an alignment between the generated LLM response and the predefined ground truth response.

At step 716, the method 700 may include determining one or more errors associated with the project to be tested based on the generated performance score. In an aspect, to determine the one or more errors associated with the project, the method 700 may include identifying one or more of a hallucination level, biases, inconsistencies, and factual inaccuracies associated with the project to be tested based on the generated performance score. Further, the method 700 may include assigning error severity levels to the project to be tested based on the identified one or more of hallucination level, the biases, the inconsistencies, and the factual inaccuracies associated with the project to be tested. For example, the error severity levels may include one or more of logical inconsistencies, ethical violations, a non-compliance with domain-specific constraints and the like. Furthermore, the method 700 may include generating a detailed error log consisting of one or more of error classification, an occurrence frequency, and a correlation with specific test scenarios based on the assigned error severity levels.

At step 718, the method 700 may include generating one or more recommendations for rectifying the determined at least one error using the Gen AI model. For example, the one or more recommendations may include modification to the plurality of KPIs, prediction of KPIs, deployment decisions of the project, a bias mitigation recommendation and the like. At step 720, the method 700 may include outputting the generated one or more recommendations, the performance score, and the determined plurality of KPIs on a user interface of a user device.

In some examples, the method 700 may include obtaining at least one feedback on the plurality of KPIs from the at least one data source. Further, the method 700 may include continuously fine-tuning the determined Gen AI model, and the plurality of KPIs based on the obtained at least one feedback. Furthermore, the method 700 may include generating updated plurality of KPIs for the project based on the fine-tuned Gen AI model.

Implementations of the present disclosure provide technical solutions to multiple technical problems that arise in the context of testing of the project. The proposed disclosure not only to build a testing framework that can help automate the Gen AI centric testing but also, provide intelligence in KPI selection, execution and processing. Based on the use case and information of the project, the testing framework can intelligently strategize on which KPIs are the best fit for testing.

Implementations of the present disclosure is based on NLP, ML and LLM models. Further, the present disclosure analyzes language-based questions and answers through a set of more than 100 KPIs. Also, the implementations of the present disclosure can automatically detect and report drift in answers and expert generated responses.

The Gen AI testing Framework of the present disclosure addresses several critical challenges in moving generative AI applications from Proof of Concept (POC) to production. Further, the testing framework provides a standardized approach for testing Gen AI models, ensuring consistency across projects and teams. Furthermore, the testing framework of the present disclosure may automate many aspects of testing, reducing time and effort spent on validation.

Implementations of the present disclosure ensures comprehensive testing across real-world scenarios, covering edge cases and common use cases alike. The testing framework may deliver clear visibility into the testing process, with structured documentation and reporting for stakeholders. Thus, facilitating auditability by maintaining records of testing procedures, results, and decisions. The outputs of the testing framework provides clear, standardized metrics and reporting to support go or no-go deployment decisions.

Implementations of the present disclosure mitigates risks by thoroughly testing for accuracy, reliability, and robustness before production. Also, the testing framework supports tracking and evaluation of different model versions, helping manage updates and improvements efficiently. Thus, building confidence by offering a structured, repeatable testing process, ensuring that outputs from the AI models are accurate, reliable, and production-ready.

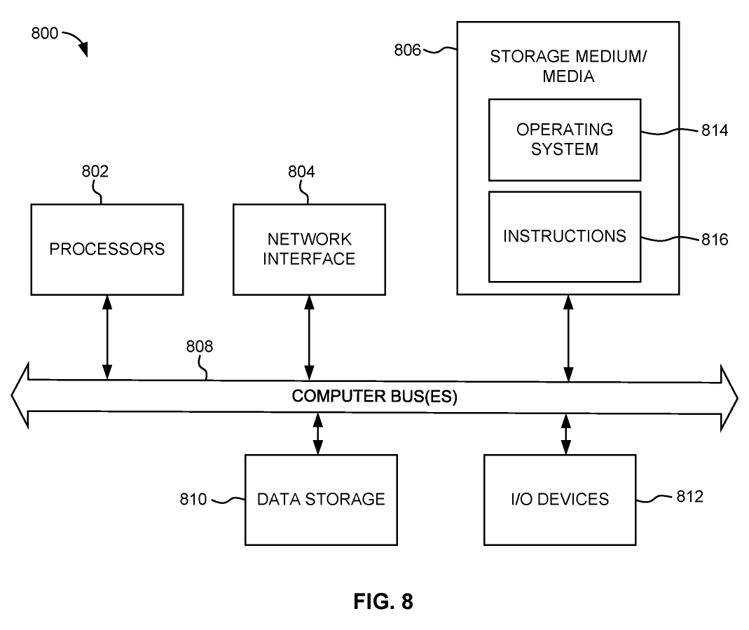

FIG. 8 illustrates a computer system 800 (i.e., the system 104) that may be used to implement the method of testing, in accordance with implementations of the present disclosure. More particularly, computing machines such as desktops, laptops, smartphones, tablets, and wearables which may be used to perform the testing. The computer system 800 may include additional components not shown and that some of the process components described may be removed and/or modified. In another example, a computer system 800 may be deployed on external-cloud platforms such as cloud, internal corporate cloud computing clusters, organizational computing resources, and/or the like.

The computer system 800 includes processor(s) 802, such as a central processing unit, ASIC or another type of processing circuit, input/output devices 804, such as a display, mouse keyboard, etc., a network interface 806, such as a Local Area Network (LAN), a wireless 802.11x LAN, a 3G or 4G mobile WAN or a WiMax WAN, and a computer-readable medium 808. Each of these components may be operatively coupled to a bus 810. The computer-readable medium 808 may be any suitable medium that participates in providing instructions to the processor(s) 802 for execution. For example, the computer-readable medium 808 may be non-transitory or non-volatile medium, such as a magnetic disk or solid-state non-volatile memory or volatile medium such as RAM. The instructions or modules stored on the computer-readable medium 808 may include machine-readable instructions 812 executed by the processor(s) 802 that cause the processor(s) 802 to perform the methods and functions of the device 104.

The system 104 may be implemented as software stored on a non-transitory processor-readable medium and executed by the processor(s) 802. For example, the computer-readable medium 808 may store an operating system 814, such as MAC OS, MS WINDOWS, UNIX, or LINUX, and code, for the testing system 104. The operating system 814 may be multi-user, multiprocessing, multitasking, multithreading, real-time, and the like. For example, during runtime, the operating system 814 is running and the code for the computer system 800 is executed by the processor(s) 802.

The computer system 800 may include a data storage 816, which may include non-volatile data storage. The data storage 816 stores any data used or generated by the system 104.

The network interface 806 connects the computer system 800 to internal systems for example, via a LAN. Also, the network interface 806 may connect the computer system 800 to the Internet. For example, the computer system 800 may connect to web browsers and other external applications and systems via the network interface 806.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term "computing system" encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer includes, or is operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 802 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network ("LAN") and a wide area network ("WAN"), e.g., the Internet. The computing system may include clients and servers. A client and server are generally remote from each other and interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system comprising:
a processor; and
a memory communicably coupled to the processor, wherein the memory comprises processor-executable instructions which, when executed by the processor, cause the processor to:
obtain input datasets associated with a project to be tested from at least one data source, wherein the input datasets comprise project data, objectives, targets, subject matter expert tags, ground truth data, and pre-defined questions and answers corresponding to the project;
determine a domain and a use case corresponding to the project to be tested based on the obtained input datasets;
determine a Generative Artificial Intelligence (Gen AI) model for the project to be tested based on the determined domain and the use case corresponding to the project to be tested;
determine a plurality of Key Performance Indices (KPIs) relevant to the project to be tested based on the determined Gen AI model, the determined domain, and the use case;
generate a plurality of test codes associated with the project based on the determined plurality of KPIs;
evaluate a performance of the project by simulating deployment of the determined plurality of test codes with the determined plurality of KPIs in a virtual environment using the Gen AI model;
generate a performance score for the project based on results of evaluation, wherein the performance score comprises a set of scores computed for each of the plurality of KPIs;
determine at least one error associated with the project to be tested based on the generated performance score;
generate at least one recommendation for rectifying the determined at least one error using the Gen AI model, wherein the at least one recommendation comprises modification to the plurality of KPIs, prediction of KPIs, deployment decisions of the project, and a bias mitigation recommendation; and
output the generated at least one recommendation, the performance score, and the determined plurality of KPIs on a user interface of a user device.

2. The system of claim 1, wherein the processor is configured to:
obtain at least one feedback on the plurality of KPIs from the at least one data source;
continuously fine-tune the determined Gen AI model and the plurality of KPIs based on the obtained at least one feedback; and
generate updated plurality of KPIs for the project based on the fine-tuned Gen AI model.

3. The system of claim 1, wherein the processor is configured to:
generate Artificial-Intelligence (AI)-based insights based on the generated performance score, the at least one recommendation and the plurality of KPIs using AI models; and
generate project summary reports based on the generated AI-based insights, wherein the project summary reports comprise explanations, descriptions, recommendations, predictions on the performance of the project in a real-world environment.

4. The system of claim 1, wherein to determine the plurality of KPIs relevant to the project to be tested based on the determined Gen AI model, the determined domain and the use case, the processor is configured to:
generate primary test codes and secondary test codes by analyzing the obtained input datasets, the determined Gen AI model, the determined domain and the use case;
generate an initial set of KPIs based on the generated primary test codes and the secondary test codes;
identify relevant KPIs from among the initial set of KPIs by classifying the project to be tested using a Machine Learning (ML)-based classification model;
identify additional KPIs based on contextual relevance by classifying the project to be tested using a Large Language Model (LLM)-based classification model;
identify previously used KPIs for similar projects based on a historical data; and
generate a consolidated list of KPIs to be used for the project based on the ML-based classification, the LLM-based classification, and the historical data.

5. The system of claim 1, wherein to determine the plurality of KPIs relevant to the project to be tested based on the determined Gen AI model, the determined domain and the use case, the processor is configured to:
classify historical projects into a plurality of test categories based on the domain, objectives, and testing requirements;
determine a test category similar to the project to be tested based on a plurality of similarity metrics;
determine the plurality of KPIs corresponding to the determined test category similar to the project to be tested;
compute a threshold value for each of the determined plurality of KPIs by computing an average of corresponding KPI thresholds within the determined test category; and
dynamically adjust the computed threshold value based on real-time system feedback and benchmarking metrics.

6. The system of claim 1, wherein to generate the plurality of test codes associated with the project based on the determined plurality of KPIs, the processor is configured to:
determine a plurality of scenarios associated with the project based on historical data, industry benchmarks, and predefined use case templates;
generate scenario-specific test cases using the Gen AI model by simulating real-world interactions and corner cases; and
validate the generated test cases by comparing the test cases with subject matter expert tags and predefined ground truth data.

7. The system of claim 1, wherein to evaluate the performance of the project by simulating deployment of the determined plurality of test codes with the determined plurality of KPIs in the virtual environment using the Gen AI model, the processor is configured to:
compute a set of Large Language Model (LLM)-specific validation metrics comprising a contextual relevance, an output coherence, a response diversity, and a compliance with ethical guidelines;
compare the computed LLM-specific validation metrics with a predefined regulatory and compliance thresholds;
simulate the deployment of the determined plurality of test codes with the determined plurality of KPIs in the virtual environment using the Gen AI model based on the comparison; and
identify deviations in a model performance of the Gen AI model and the performance of the project to be tested based on results of simulation.

8. The system of claim 1, wherein to generate the performance score for the project based on the results of evaluation, the processor is configured to:
generate a Large Language Model (LLM) response by applying a LLM prompt to the Gen AI model, wherein the LLM prompt corresponds to a test question;
extract nouns and pronouns from the generated LLM response using Natural Language Processing (NLP);
classify the extracted nouns and pronouns into predefined demographic categories, comprising at least one of a gender, an ethnicity, and a race;
define a set of bias detection thresholds for each of the predefined demographic categories;
compare the classified nouns and pronouns with the set of bias detection thresholds;
assign a bias weight to each of the predefined demographic categories based on a deviation from expected demographic balance;
compute an occurrence frequency and a distribution of each predefined demographic categories within the LLM response;
compute a bias score for the LLM response based on the computed occurrence frequency and the distribution;
determine relevancy of the extracted nouns and pronouns usage to an intent of the LLM prompt based on the computed bias score; and
refine the bias score for the LLM response based on the determined relevancy.

9. The system of claim 8, wherein to generate the performance score for the project based on the results of evaluation, the processor is configured to:
generate embedded LLM response vectors for the LLM response by performing vector embedding on the generated LLM response;
generate ground truth response vectors by performing vector embedding on a predefined ground truth response; and
compute a cosine similarity score between the embedded LLM response vectors and the ground truth response vectors, wherein the cosine similarity score measures an alignment between the generated LLM response and the predefined ground truth response.

10. The system of claim 1, wherein to determine the at least one error associated with the project to be tested based on the generated performance score, the processor is configured to:
identify at least one of a hallucination level, biases, inconsistencies, and factual inaccuracies associated with the project to be tested based on the generated performance score;
assign error severity levels to the project to be tested based on the identified at least one hallucination level, the biases, the inconsistencies, and the factual inaccuracies associated with the project to be tested, wherein the error severity levels comprise at least one of logical inconsistencies, ethical violations, and a non-compliance with domain-specific constraints; and
generate a detailed error log comprising at least one of error classification, an occurrence frequency, and a correlation with specific test scenarios based on the assigned error severity levels.

11. A method comprising:
obtaining, by a processor, input datasets associated with a project to be tested from at least one data source, wherein the input datasets comprise project data, objectives, targets, subject matter expert tags, ground truth data, and pre-defined questions and answers corresponding to the project;
determining, by the processor, a domain and a use case corresponding to the project to be tested based on the obtained input datasets;
determining, by the processor, a Generative Artificial Intelligence (Gen AI) model for the project to be tested based on the determined domain and the use case corresponding to the project to be tested;
determining, by the processor, a plurality of Key Performance Indices (KPIs) relevant to the project to be tested based on the determined Gen AI model, the determined domain, and the use case;
generating, by the processor, a plurality of test codes associated with the project based on the determined plurality of KPIs;
evaluating, by the processor, a performance of the project by simulating deployment of the determined plurality of test codes with the determined plurality of KPIs in a virtual environment using the Gen AI model;
generating, by the processor, a performance score for the project based on results of evaluation, wherein the performance score comprises a set of scores computed for each of the plurality of KPIs;
determining, by the processor, at least one error associated with the project to be tested based on the generated performance score;
generating, by the processor, at least one recommendation for rectifying the determined at least one error using the Gen AI model, wherein the at least one recommendation comprises modification to the plurality of KPIs, prediction of KPIs, deployment decisions of the project, and a bias mitigation recommendation; and
outputting, by the processor, the generated at least one recommendation, the performance score, and the determined plurality of KPIs on a user interface of a user device.

12. The method of claim 11, further comprising:
obtaining, by the processor, at least one feedback on the plurality of KPIs from the at least one data source;
continuously fine-tuning, by the processor, the determined Gen AI model, and the plurality of KPIs based on the obtained at least one feedback; and
generating, by the processor, updated plurality of KPIs for the project based on the fine-tuned Gen AI model.

13. The method of claim 11, wherein determining the plurality of KPIs relevant to the project to be tested based on the determined Gen AI model, the determined domain and the use case comprises:
generating, by the processor, primary test codes and secondary test codes by analyzing the obtained input datasets, the determined Gen AI model, the determined domain and the use case;
generating, by the processor, an initial set of KPIs based on the generated primary test codes and the secondary test codes;
identifying, by the processor, relevant KPIs from among the initial set of KPIs by classifying the project to be tested using a Machine Learning (ML)-based classification model;
identifying, by the processor, additional KPIs based on contextual relevance by classifying the project to be tested using a Large Language Model (LLM)-based classification model;
identifying, by the processor, previously used KPIs for similar projects based on a historical data; and
generating, by the processor, a consolidated list of KPIs to be used for the project based on the ML-based classification, the LLM-based classification, and the historical data.

14. The method of claim 11, wherein determining the plurality of KPIs relevant to the project to be tested based on the determined Gen AI model, the determined domain and the use case comprises:
classifying, by the processor, historical projects into a plurality of test categories based on the domain, objectives, and testing requirements;
determining, by the processor, a test category similar to the project to be tested based on a plurality of similarity metrics;
determining, by the processor, the plurality of KPIs corresponding to the determined test category similar to the project to be tested;
computing, by the processor, a threshold value for each of the determined plurality of KPIs by computing an average of corresponding KPI thresholds within the determined test category; and
dynamically adjusting, by the processor, the computed threshold value based on real-time system feedback and benchmarking metrics.

15. The method of claim 11, wherein generating the plurality of test codes associated with the project based on the determined plurality of KPIs comprises:
determining, by the processor, a plurality of scenarios associated with the project based on historical data, industry benchmarks, and predefined use case templates;
generating, by the processor, scenario-specific test cases using the Gen AI model by simulating real-world interactions and corner cases; and
validating, by the processor, the generated test cases by comparing the test cases with subject matter expert tags and predefined ground truth data.

16. The method of claim 11, wherein evaluating the performance of the project by simulating deployment of the determined plurality of test codes with the determined plurality of KPIs in the virtual environment using the Gen AI model comprises:
computing, by the processor, a set of Large Language Model (LLM)-specific validation metrics comprising a contextual relevance, an output coherence, a response diversity, and a compliance with ethical guidelines;
comparing, by the processor, the computed LLM-specific validation metrics with a predefined regulatory and compliance thresholds;
simulating, by the processor, the deployment of the determined plurality of test codes with the determined plurality of KPIs in the virtual environment using the Gen AI model based on comparison; and
identifying, by the processor, deviations in a model performance of the Gen AI model and the performance of the project to be tested based on results of simulation.

17. The method of claim 11, wherein generating the performance score for the project based on the results of evaluation comprises:
generating, by the processor, a Large Language Model (LLM) response by applying a LLM prompt to the Gen AI model, wherein the LLM prompt corresponds to a test question;
extracting, by the processor, nouns and pronouns from the generated LLM response using Natural Language Processing (NLP);
classifying, by the processor, the extracted nouns and pronouns into predefined demographic categories, comprising at least one of a gender, an ethnicity, and a race;
defining, by the processor, a set of bias detection thresholds for each of the predefined demographic categories;
comparing, by the processor, the classified nouns and pronouns with the set of bias detection thresholds;
assigning, by the processor, a bias weight to each of the predefined demographic categories based on a deviation from expected demographic balance;
computing, by the processor, an occurrence frequency and a distribution of each predefined demographic categories within the LLM response;
computing, by the processor, a bias score for the LLM response based on the computed occurrence frequency and the distribution;
determining, by the processor, relevancy of the extracted nouns and pronouns usage to an intent of the LLM prompt based on the computed bias score; and
refining, by the processor, the bias score for the LLM response based on the determined relevancy.

18. The method of claim 17, wherein generating the performance score for the project based on the results of evaluation comprises:
generating, by the processor, embedded LLM response vectors for the LLM response by performing vector embedding on the generated LLM response;
generating, by the processor, ground truth response vectors by performing vector embedding on a predefined ground truth response; and
computing, by the processor, a cosine similarity score between the embedded LLM response vectors and the ground truth response vectors, wherein the cosine similarity score measures an alignment between the generated LLM response and the predefined ground truth response.

19. The method of claim 11, wherein determining the at least one error associated with the project to be tested based on the generated performance score comprises:
identifying, by the processor, at least one of a hallucination level, biases, inconsistencies, and factual inaccuracies associated with the project to be tested based on the generated performance score;
assigning, by the processor, error severity levels to the project to be tested based on the identified at least one hallucination level, the biases, the inconsistencies, and the factual inaccuracies associated with the project to be tested, wherein the error severity levels comprise at least one of logical inconsistencies, ethical violations, and a non-compliance with domain-specific constraints; and
generating, by the processor, a detailed error log comprising at least one of error classification, an occurrence frequency, and a correlation with specific test scenarios based on the assigned error severity levels.

20. A non-transitory computer readable medium comprising a processor-executable instructions that cause a processor to:
obtain input datasets associated with a project to be tested from at least one data source, wherein the input datasets comprise project data, objectives, targets, subject matter expert tags, ground truth data, and pre-defined questions and answers corresponding to the project;
determine a domain and a use case corresponding to the project to be tested based on the obtained input datasets;
determine a Gen AI model for the project to be tested based on the determined domain and the use case corresponding to the project to be tested;
determine a plurality of Key Performance Indices (KPIs) relevant to the project to be tested based on the determined Gen AI model, the determined domain, and the use case;
generate a plurality of test codes associated with the project based on the determined plurality of KPIs;
evaluate a performance of the project by simulating deployment of the determined plurality of test codes with the determined plurality of KPIs in a virtual environment using the Gen AI model;
generate a performance score for the project based on results of evaluation, wherein the performance score comprises a set of scores computed for each of the plurality of KPIs;
determine at least one error associated with the project to be tested based on the generated performance score;
generate at least one recommendation for rectifying the determined at least one error using the Gen AI model, wherein the at least one recommendation comprises modification to the plurality of KPIs, prediction of KPIs, deployment decisions of the project, and a bias mitigation recommendation; and
output the generated at least one recommendation, the performance score, and the determined plurality of KPIs on a user interface of a user device.
